(19) United States
(12) Patent Application Publication
(10) Pub. No.: US 2015/0122960 A1
(43) Pub. Date: May 7, 2015

(54) Guitar display frames

(71) Applicant: Richard Eward, Yucaipa, CA (US)

(72) Inventor: Richard Eward, Yucaipa, CA (US)

(21) Appl. No.: 14/544,160

(22) Filed: Feb. 17, 2012

(51) Int. Cl. A47G 1/06; F16M 13/02; A47G 1/16

(52) U.S. Cl. CPC A47G 1/0616; A47G 1/16; F16M 13/02
USPC 248/231.91; 248/309.1

(57) ABSTRACT

I am inventing my Guitar Display Frame because I would like to hang a guitars in a fine frame on a wall, like art. Frames will be custom made. Depending on the size of the guitar. Whether it be an acoustic guitar, electric guitar, or a electric bass. With a wide variety of frame stock and back board fabrics to choose, one could pick what he or she likes, and I will custom build it for them. With a Illuminated light on top of the frame to make your Guitar stand out. I have not seen this Display Frame on the market and so I would like to make it available to anyone who desires one. As for the light in drawing FIG. 7. I can design my own light or seek no patent on the physical light part. This can be a item added on as a accessory from a already manufactured light, yet still be part of the overall patent idea.

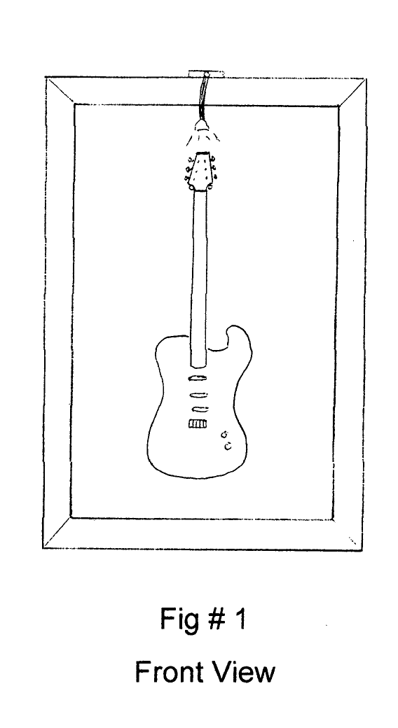

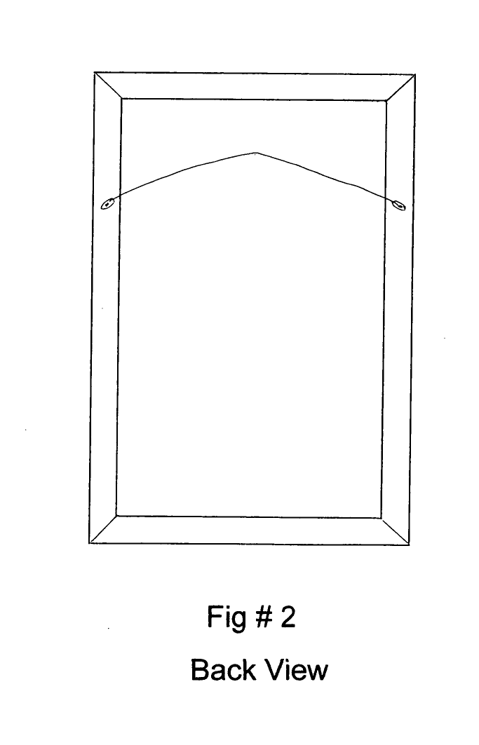

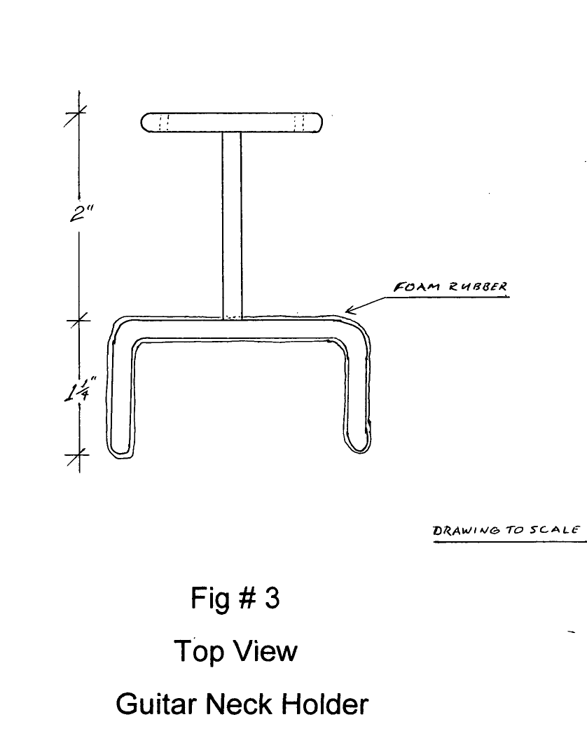

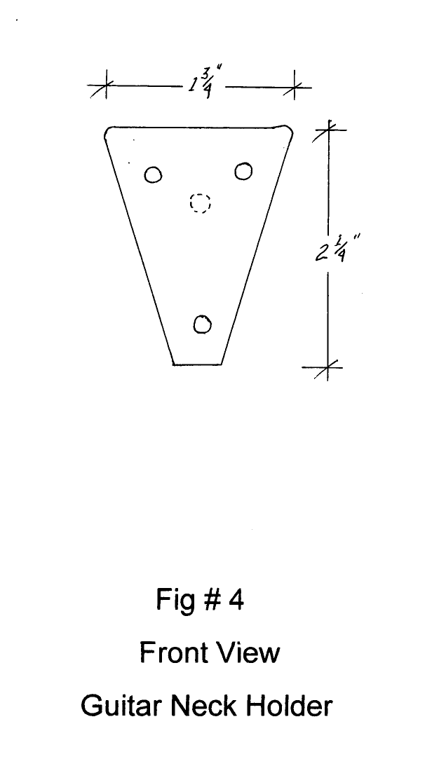

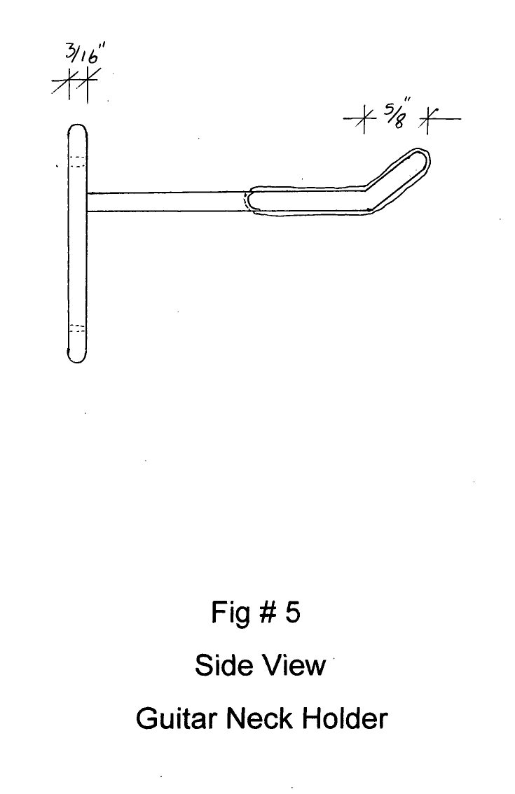

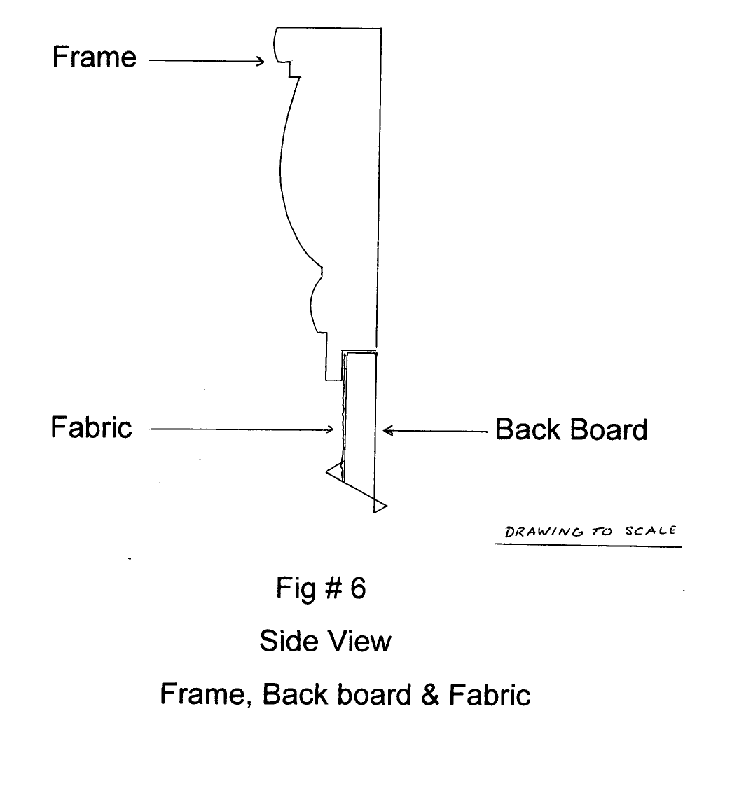

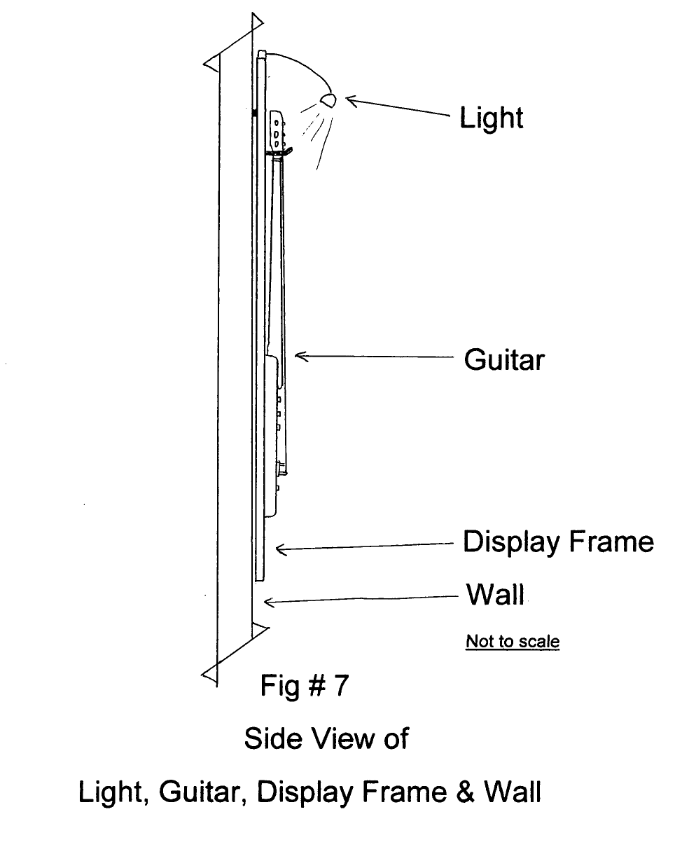

Drawing FIG. #1: Front view shows how the guitar is centered in frame. Also shows where the guitar will be held by the neck of the guitar holder.

Drawing FIG. #2: Shows how the frame will be hung to the wall by a 40 pound wire attached to both sides of the frame.

Drawing FIG. #3: Top view is made out of 3/16 steel, with a foam coating over the outer part where the guitar neck will rest.

Drawing FIG. #4: Shows the three holes 3/16 in diameter. The screws are 3/16 Allen bolt screws and nuts.

Drawing #5: Shows the guitar holder having a 45 degree bend at the end to keep the guitar from falling off.

Drawing FIG. #6: Top corner shows where the fabric is glued onto the ¼ in plywood or OSB back board.

Drawing FIG. #7:

Shows the light that is fastened to the top of the frame and illuminates down onto the instrument.

1. Building a Custom display frame to hang a guitar on, where a costumer can choose a variety of frame stock and fabric stock.
